(19) United States
(12) Patent Application Publication
(10) Pub. No.: US 2018/0072597 A1
(43) Pub. Date: Mar. 15, 2018

(54) WATER TREATMENT SYSTEM AND WATER TREATMENT PROCESS

(71) Applicant: Mitsubishi Electric Corporation, Tokyo (JP)

(72) Inventors: EIJI IMAMURA, Tokyo (JP); Kyohei AKETAGAWA, Tokyo (JP); Nozomu YASUNAGA, Tokyo (JP)

(73) Assignee: Mitsubishi Electric Corporation, Tokyo (JP)

(21) Appl. No.: 15/566,815

(22) PCT Filed: May 18, 2015
(86) PCT No.: PCT/JP2015/064138

§ 371 Date: Oct. 16, 2017

(51) Int. Cl. C02F 3/26; C02F 3/12; C02F 1/44; C02F 1/78

(52) U.S. Cl. CPC C02F 3/26; C02F 3/1221; C02F 3/1252; C02F 2101/30; C02F 1/44; C02F 1/78; C02F 3/1268

(57) ABSTRACT

A water treatment system including: a biological treatment stage for treating an organic wastewater by an action of a microorganism; an ozone gas producing stage for generating ozone gas; a sludge transferring stage for withdrawing and transferring a part of the microorganism-mixed liquid in the biological treatment stage; an ozone treatment stage for bringing ozone into contact with the part of the microorganism-mixed liquid transferred; and a treated liquid returning stage for returning the treated liquid after the ozone treatment from the ozone treatment stage to the biological treatment stage. Undecomposed aggregated microorganisms after the ozone treatment are separated and concentrated, and an ozone treatment is selectively applied to the aggregated undecomposed microorganisms thus separated and concentrated.

### TECHNICAL FIELD

The present invention relates to a water treatment system for treating a water containing organic substances, and a water treatment process.

### BACKGROUND ART

Water treatment systems using a process for treating a wastewater or other waters with microorganisms, such as a conventional activated sludge process, have heretofore known. Such a water treatment system uses a microorganism that can consume organic substances as substrates, and a treatment for purifying a water is carried out by allowing the microorganism to consume organic substances in the water as substrates.

When microorganisms consume organic substances in a water through the water treatment, the microorganisms in the water will grow. For example, in a conventional activated sludge process, a sedimentation tank is placed as a subsequent stage of an aeration tank so as to store microorganisms flowing out from the aeration tank. However, when the microorganisms excessively grow, microorganisms flowing out of the aeration tank may exceed the storage allowance of the sedimentation tank, and therefore the excessively grown microorganisms have to be discharged out of the water treatment system as excess sludge. In addition, when the amount of microorganisms in the aeration tank excessively increases in the membrane bioreactor process (MBR), clogging of a membrane may be caused, and therefore the excessively grown microorganisms have to be appropriately discharged as excess sludge so that the amount of the microorganisms falls within a proper range.

As a method for disposal of the excess sludge discharged, a method using incineration, a method of disposal by fermenting the sludge under an anaerobic condition (digestion treatment), and the like may be employed. Any method requires a great deal of energy and cost. Accordingly, in a water treatment process using microorganisms, reduction in the amount of excess sludge discharged is demanded.

PTL 1 proposes a water treatment system using ozone for reducing the amount of excess sludge discharged. In this water treatment system, a water containing microorganisms grown through a treatment is brought into contact with ozone to decompose the microorganisms, and a water treatment by the microorganisms is applied again using organic substances contained in the water and the microorganisms decomposed by the ozone (referred to as decomposed microorganisms) as substrates, thereby reducing the amount of excess sludge discharged.

### CITATION LIST

### Patent Literature

PTL 1: JP-A-11-42494

### SUMMARY OF INVENTION

### Technical Problem

In the water treatment disclosed in PTL 1, a microorganism-mixed liquid which is a treated water to be subjected to the water treatment exists in an aeration tank containing microorganisms, and the microorganism-mixed liquid which may contain the microorganisms grown through the water treatment is withdrawn from the aeration tank and ozone is injected into a part of the withdrawn microorganism-mixed liquid via an ejector, and the microorganism-mixed liquid resulting from the ozone treatment by injecting ozone is returned to the aeration tank, thereby achieving the reduction of the amount of excess sludge discharged.

However, the above method using ozone still has room for improvement. For example, in this method, the microorganisms are decomposed by being brought into a contact reaction with ozone, and ozone is consumed by not only a reaction with the undecomposed microorganisms, but also reactions with the remaining organic substances, the decomposed microorganisms which have already been decomposed, and an organic substance leaking from the decomposed microorganisms. The reactions of ozone with the remaining organic substances, the decomposed microorganisms, and the organic substance leaking from the decomposed microorganisms, which are not targets of the reaction, lead to a reduced efficiency of ozone reaction with the grown microorganisms which are the target of the reaction. For this reason, for achieving a sufficient effect of excess sludge reduction, it is required to take into consideration the amount of ozone consumed by reactions with substances that are not targets of the reaction.

The present invention is made for solving the above problem, and has an object to provide a water treatment system and a wastewater treatment process in which grown undecomposed microorganisms are allowed to selectively react with ozone to maintain the reaction efficiency between the microorganisms as the target of the reaction and ozone at a high level, and a high effect of excess sludge reduction can be achieved with a small amount of ozone injected.

### Solution to Problem

The water treatment system according to the present invention includes a microorganism treatment unit configured to treat a water with microorganisms, a withdrawing unit configured to withdraw a partial water from the water treated by the microorganism treatment unit, an ozone generation unit configured to generate ozone, and an ozone reaction unit configured to allow the partial water withdrawn by the withdrawing unit to react with ozone generated by the ozone generation unit. The water treatment system according to the present invention also includes a water tank having a height in the vertical direction and configured so that the partial water reacted by the ozone reaction unit flows therein and is stored therein, and a returning unit connected to an underside in the vertical direction of the water tank and configured to return at least a part of the partial water stored in the water tank to the microorganism treatment unit. The water tank includes a moving means that moves the partial water flowing therein upwardly in the vertical direction and a flow regulation means that is disposed above the moving means and regulates flow of the partial water moved by the moving means.

The water treatment process according to the present invention includes a treating step for treating a water with microorganisms. The water treatment process according to the present invention also includes a withdrawing step for withdrawing a partial water from the water treated, and a generating step for generating ozone, a reacting step for allowing the partial water withdrawn to react with the ozone generated, a storing step for allowing the partial water reacted to flow into a water tank having a height in the vertical direction to store the partial water therein, a moving step for moving the partial water flowing therein upwardly in the vertical direction, a flow regulating step for regulating flow of the partial water moved, and a retreating step for treating again at least a part of the partial water regulated in flow with microorganisms.

### Advantageous Effects of Invention

According to the present invention, undecomposed microorganisms which are a reaction target can be allowed to selectively react with ozone. Accordingly, it is possible to maintain the reaction efficiency between the undecomposed microorganisms and ozone at a high level, achieving a high effect for excess sludge reduction with a relatively small amount of ozone injected. In addition, since the water treatment can be performed with a relatively small amount of ozone injected, it is possible to suppress toxicity of ozone which may occur due to a high concentration of ozone, thereby achieving a good and stable water quality after treatment.

### BRIEF DESCRIPTION OF DRAWINGS

FIG. 1 is a schematic diagram showing a configuration of a water treatment system according to Embodiment 1.

FIG. 2 is a schematic view showing an example of a guide pipe included in a water treatment system.

FIG. 3 is a schematic view showing an example of a guide pipe included in a water treatment system.

FIG. 4 is a three dimensional view for explaining an example of a flow regulator included in a water treatment system.

FIG. 5 is a three dimensional view for explaining an example of a flow regulator included in a water treatment system.

FIG. 6 is a cross sectional view for explaining an example of a structure of a flow regulator.

FIG. 7 is a cross sectional view for explaining an example of a structure of a flow regulator.

FIG. 8 is a cross sectional view for explaining a structure of a sludge concentration and separation device and a flow of water in a tank.

FIG. 9 is a schematic view for explaining an aperture ratio of a flow regulator.

FIG. 10 is a schematic view for explaining an inclination angle of a flow regulator.

FIG. 11 is a schematic diagram showing a configuration of a water treatment system according to Embodiment 2.

FIG. 12 is a schematic diagram showing a configuration of a water treatment system according to Embodiment 3.

FIG. 13 is a schematic diagram showing a modification example of the water treatment system according to Embodiment 3.

FIG. 14 is a schematic diagram showing a configuration of a water treatment system according to Embodiment 4.

FIG. 15 is a schematic diagram showing a modification example of the water treatment system according to Embodiment 4.

FIG. 16 is a schematic diagram showing a modification example of the water treatment system according to Embodiment 4.

FIG. 17 is a schematic diagram showing a configuration of a water treatment system according to Embodiment 5.

FIG. 18 is a schematic diagram for explaining a configuration of an ozone water production unit provided in a water treatment system.

FIG. 19 is a schematic diagram for showing a modification example of the ozone water production unit provided in a water treatment system.

FIG. 20 is a graph showing a relation between aperture ratio and amount of ozone.

FIG. 21 is a graph showing a relation between number of days for treatment and BOD removal ratio.

### DESCRIPTION OF EMBODIMENTS

Embodiments of the water treatment system and the water treatment process disclosed in the present application are described in detail below with reference to the accompanying drawings. Incidentally, each of the following Embodiments is merely an example, and is not to limit the present invention. Embodiment 1.

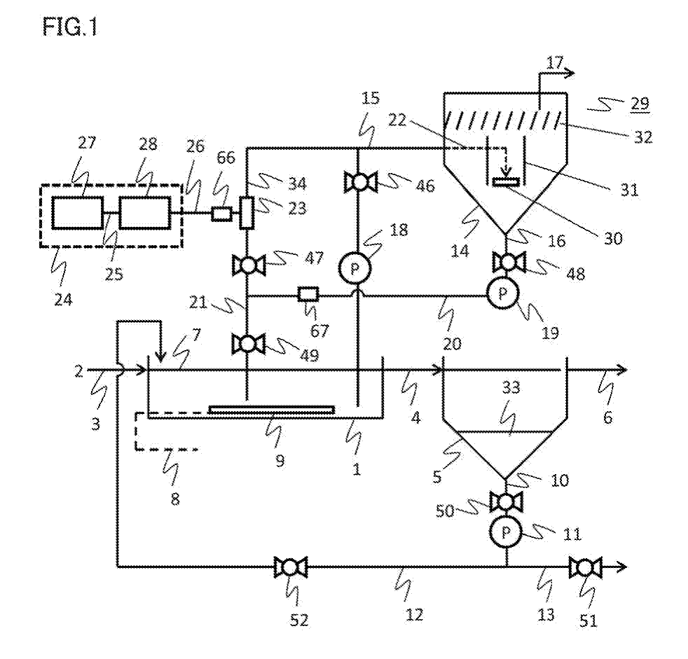

FIG. 1 is a schematic diagram showing an example of a water treatment system according to Embodiment 1. In the water treatment system, a conventional activated sludge process is applied in a biological treatment stage.

The water treatment system includes a component, such as an aeration tank 1, as an example of a microorganism treatment unit configured to treat a water with microorganisms. The aeration tank 1 contains an aerobic microorganism capable of utilizing organic substances as substrates. A wastewater introducing path 3 that receives a wastewater 2 and a flow-out path 4 that receives a flow-out water from the aeration tank 1 are connected to the aeration tank 1. The flow-out path 4 is also connected to a sedimentation tank 5 and transfers the flow-out water from the aeration tank 1 to the sedimentation tank 5. A treated water releasing path 6 is connected to the sedimentation tank 5, and a supernatant water in the sedimentation tank flows out via the treated water releasing path 6.

The wastewater 2, as used herein, is an example of a water which is a target to be treated in a water treatment system. When the wastewater 2 is, for example, a municipal sewage, a wastewater discharged from a food processing plant, a wastewater discharged from a semiconductor manufacturing plant, and the like, a relatively large amount of organic substances to be treated are contained.

In a water treatment, microorganisms consume the organic substances in the aeration tank 1, and when the microorganisms excessively grow, the excessively grown microorganisms become excess sludge, and the microorganisms flowing out of the aeration tank 1 may exceed the storage allowance of the sedimentation tank 5.

In the aeration tank 1, a water-microorganism mixed liquid 7 which is the wastewater 2 in a state where the excessively grown microorganisms may be contained is stored. Also in the aeration tank 1, air is released from an air diffuser 9 through an air introducing path 8 and fed to the microorganism-mixed liquid 7. A sludge withdrawing pipe 10 is connected to the bottom of the sedimentation tank 5, and the sludge withdrawing pipe 10 is connected to a sludge withdrawing pump 11. The ejection side of the sludge withdrawing pump 11 is divided into a sludge returning pipe 12 and a sludge discharging pipe 13.

As used herein, a merely “sludge” refers to a collection of microorganisms, and a “separated sludge” refers to a sludge that is separated out when microorganisms that have flown out of an aeration tank are subjected to solid-liquid separation. An “excess sludge” refers to a sludge that has to be discarded since microorganisms grow in a biological treatment stage to produce microorganisms and excess microorganisms are accumulated in the wastewater treatment system.

The water treatment system includes an ozone reaction tank 14, and to the ozone reaction tank 14, a sludge transferring pipe 15, a sludge extracting pipe 16, and a waste-ozone releasing path 17 are connected. The sludge transferring pipe 15 is inserted into the aeration tank 1, and a sludge transferring pump 18 is placed on the sludge transferring pipe 15. Thus, by the sludge transferring pump 18, the microorganism-mixed liquid 7 in the aeration tank 1 can be transferred through the sludge transferring pipe 15 into the ozone reaction tank 14. A sludge circulating pump 19 is connected to the sludge extracting pipe 16. The ejection side of the sludge circulating pump 19 is divided into a sludge circulating pipe 20 and a treated liquid returning pipe 21. The sludge circulating pipe 20 is connected to the sludge transferring pipe 15, and the sludge transferring pipe 15 is connected to a sludge introducing pipe 22 placed in the ozone reaction tank 14. A flowmeter 67 for measuring a flow rate of a liquid flowing through the pipe and an ejector 23 are provided on the sludge circulating pipe 20.

The water treatment system also includes an ozone production device 24, an ozone transferring path 25, and an ozone injecting path 26. In FIG. 11, the ozone production device 24 includes an ozone generator 27 and an ozone concentrator 28, and the ozone transferring path 25 is connected to the ozone generator 27 and the ozone concentrator 28. The ozone injecting path 26 is connected to the ozone concentrator 28 and the ejector 23. A flowmeter 66 for measuring an ozone gas flow rate is provided on the ozone injecting path.

The water treatment system further includes a sludge concentration and separation device 29 in the ozone reaction tank 14, and valves 46 to 52 on the respective pipes. The sludge concentration and separation device 29 is composed of a baffle plate 30, a guide pipe 31, and a flow regulator 32.

The operation of the water treatment system of FIG. 1 having the above configuration is as follows.

### <Biological Treatment Stage>

The wastewater 2 containing organic substances is introduced into the aeration tank 1 through the wastewater introducing path 3.

In the aeration tank 1, the microorganism-mixed liquid 7 containing an aerobic microorganism that can utilize the organic substances as substrates is stored. Accordingly, in the aeration tank 1, the organic substances contained in the wastewater 2 are removed from the water, whereby the wastewater 2 is purified.

The wastewater 2 purified in the aeration tank 1 is retained for a prescribed retention time and then flows out through the flow-out path 4 into the sedimentation tank 1 as a flow-out water.

In the sedimentation tank 5, the microorganisms in the microorganism-mixed liquid 7 flowing therein together with the flow-out water from the aeration tank are settled and separated out.

The separated microorganisms accumulate on the bottom of the sedimentation tank 5 as a separated sludge 33, while a clear supernatant water is released from the top of the sedimentation tank 5 through the treated water releasing path 6.

The separated sludge 33 accumulating on the bottom of the sedimentation tank 5 is withdrawn through the sludge withdrawing pipe 10 by the sludge withdrawing pump 11. The withdrawn separated sludge 33 is returned through the sludge returning pipe 12 into the aeration tank 1.

As described above, since the wastewater treatment has microorganisms utilize organic substances in a wastewater, the organic substances can be removed from the wastewater, whereas the microorganisms grown by utilizing organic substances gradually accumulate in the system. Accordingly, when solid matter such as the microorganisms excessively accumulates in the system, the solid matter is discharged out of the system as an excess sludge through the sludge discharging pipe 13, and processed as a waste. As already described, the disposal of the excess sludge requires enormous energy and cost, and it is required to reduce the amount of the excess sludge discharged.

### <Ozone Gas Producing Stage>

In Embodiment 1, the ozone gas producing stage includes an ozone generating stage and an ozone concentrating stage.

### [Ozone Generating Stage]

In the ozone producing stage, ozone is produced by the ozone generator 27 which is an example of an ozone generation unit configured to generate ozone. The ozone generator 27 may be any device as long as an ozone gas is generated therein, and examples include a device which produces ozone by electrical discharge using oxygen or air as a raw material.

### [Ozone Concentrating Stage]

In the ozone concentrating stage, ozone produced in the ozone generator 27 is concentrated and stored in the ozone concentrator 28. The ozone concentrator 28 may be any device as long as ozone can be concentrated and stored therein, and examples include a device using a container filled with a silica gel as an ozone adsorbent in which ozone absorbed can be desorbed and released by changing the pressure or temperature in the container.

The ozone concentrated in the ozone concentrating stage is released from the ozone concentrator 28 in an ozone injecting and circulating stage described later and used for decomposing the microorganisms.

The ozone generating stage and the ozone concentrating stage described above are conducted in this order at every release of ozone from the ozone concentrator, and a state with ozone stored is always maintained in the ozone concentrator 28.

Hereinunder, a sludge transferring stage, an ozone treatment stage, and a treated sludge returning stage will be shown. The stages are conducted in this order, and a batch treatment is carried out with the three stages as one cycle. That is, after the three stages are performed in this order and the treated sludge returning stage is completed, the sludge transferring stage is started.

A downtime may be optionally provided between the completion of the treated sludge returning stage and the start of the sludge transferring stage to intermittently perform the above three stages.

### <Sludge Transferring Stage>

While performing the biological treatment stage and the ozone gas producing stage, the sludge transferring stage is started.

In the sludge transferring stage, the valve 46 is opened and a part of the microorganism-mixed liquid 7 stored in the aeration tank 1 is sucked through the sludge transferring pipe 15 by the sludge transferring pump 18, and transferred into the ozone reaction tank 14 which is an example of the ozone reaction unit according to the present invention. At this time, the valve 48 provided on the sludge extracting pipe 16 is in a closed state so that the microorganism-mixed liquid 7 does not flow out from the ozone reaction tank 14 and a predetermined amount of sludge is transferred into the ozone reaction tank 14. The combination of the valve 46, the sludge transferring pipe 15, and the sludge transferring pump 18 is one example of the withdrawing unit configured to withdraw a partial water from the water treated by the microorganism treatment unit.

The amount of sludge transferred may be controlled by the operation time of the sludge transferring pump 18, may be controlled by providing an integrating flowmeter on the sludge transferring pipe 15 to check the amount of the sludge flowing through the pipe, or may be controlled by providing a level sensor in the ozone reaction tank 14 to stop the transfer when a predetermined water level is reached.

### <Ozone Treatment Stage>

In the water treatment system according to the present invention, the reduction in the amount of excess sludge generated is achieved through decomposition of microorganisms by ozone. In order to efficiently bring the microorganisms into contact with ozone, the ozone treatment stage includes two stages of the ozone injecting and circulating stage and a sludge concentrating stage described below, and the stages for predetermined times are repeatedly carried out.

### [Ozone Injecting and Circulating Stage]

In the ozone injecting and circulating stage, the valve 48 on the sludge extracting pipe 16, and the valve 47 on the sludge circulating pipe 20 are opened, whereas the valve 46 on the sludge transferring pipe 15 is closed. The microorganism-mixed liquid 7 in the ozone reaction tank 14 is withdrawn from the sludge extracting pipe 16 by the sludge circulating pump 19 and fed into the sludge circulating pipe 20.

When the microorganism-mixed liquid 7 passes through the ejector 23 placed on the sludge circulating pipe 20, an ozone gas stored in the ozone concentrator 28 is released from the ozone concentrator 28, the microorganism-mixed liquid 7 comes into contact with the ozone gas, and excessively grown microorganisms present in the microorganism-mixed liquid 7 are decomposed by ozone.

As a method of injecting ozone, for example, a method in which an air diffuser is provided in the ozone reaction tank 14 and ozone is released from the air diffuser may be adopted, but a method using a venturi device such as an ejector is more preferred since the efficiency of ozone absorption is higher and a more efficient sludge reduction can be achieved with a small amount of ozone.

Here, the efficiency of ozone dissolution into the microorganism-mixed liquid depends greatly on the ratio of the ozone gas flow rate to the microorganism-mixed liquid flow rate in the ejector 23, the smaller the proportion of the ozone gas flow rate, the more efficiently the ozone can be dissolved. Accordingly, the ratio (g/L) of the ozone gas flow rate to the microorganism-mixed liquid flow rate in the ejector 23 may be 0.05 to 0.4, and preferably 0.1 to 0.3.

By concentrating an ozone gas by the ozone concentrator 28 in the ozone gas producing stage as in the Embodiment, an ozone gas having an extremely high concentration of approximately from 1000 to 2000 mg/NL can be obtained, and it becomes possible to quickly complete the reaction of ozone with the microorganisms. However, it is not necessarily possible to obtain the effect of the invention of the present application only with the high concentrated ozone as above. That is, the effect of the invention of the present application can also be obtained by, for example, in the ozone gas producing stage, directly injecting an ozone gas of approximately 100 mg/NL generated in an ozone generator into the microorganism-mixed liquid 7 without ozone concentration.

### [Sludge Concentrating Stage]

In the sludge concentrating stage, the microorganism-mixed liquid 7 flowing through the sludge circulating pipe 20 flows via the sludge introducing pipe 22 into the ozone reaction tank 14. The sludge introducing pipe 22 has been inserted into the central area of the ozone reaction tank 14, and the introduced microorganism-mixed liquid 7 is ejected downwardly in the vertical direction from the central area of the ozone reaction tank 14.

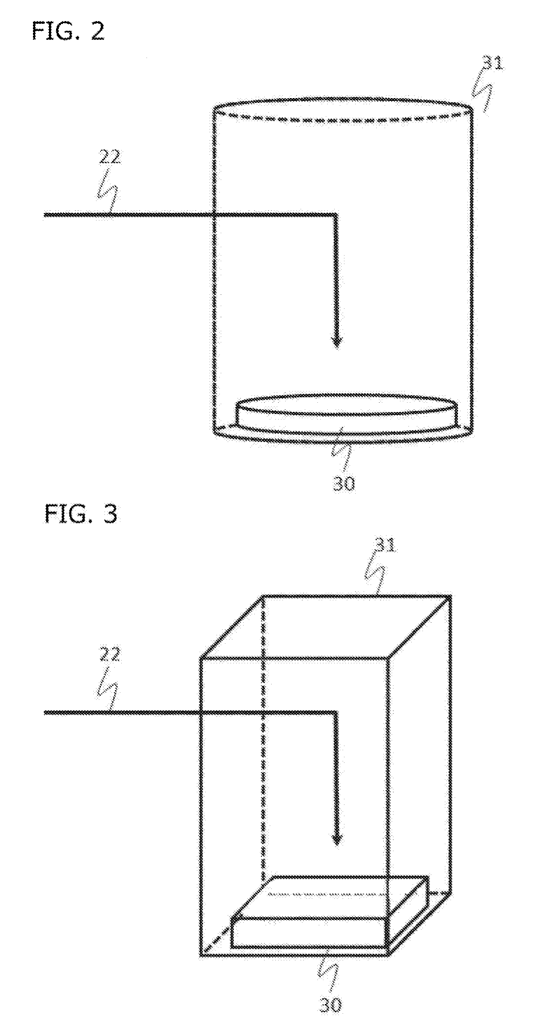

The ejected microorganism-mixed liquid is sprayed onto the baffle plate 30 placed below the outlet port of the sludge introducing pipe 22, and the microorganism-mixed liquid flow is changed in the flow direction into the horizontal direction. The baffle plate 30 is placed inside a guide pipe 31 of a hollow cylinder as shown in FIG. 2 or a rectangular parallelepiped as shown in FIG. 3a. Thus, a microorganism-mixed liquid flow 34 is changed in the flow direction upwardly by an inner wall of the guide pipe 31, and runs upwardly along the inner wall of the guide pipe 31 in the central area of the ozone reaction tank. That is, the combination of the baffle plate 30 and the inner wall of the guide pipe 31 is one example of the moving means according to the present invention.

The flow regulator 32 is placed above the guide pipe 31, and the microorganism-mixed liquid flow 34 is regulated in the course of the upward passing through the flow regulator 32.

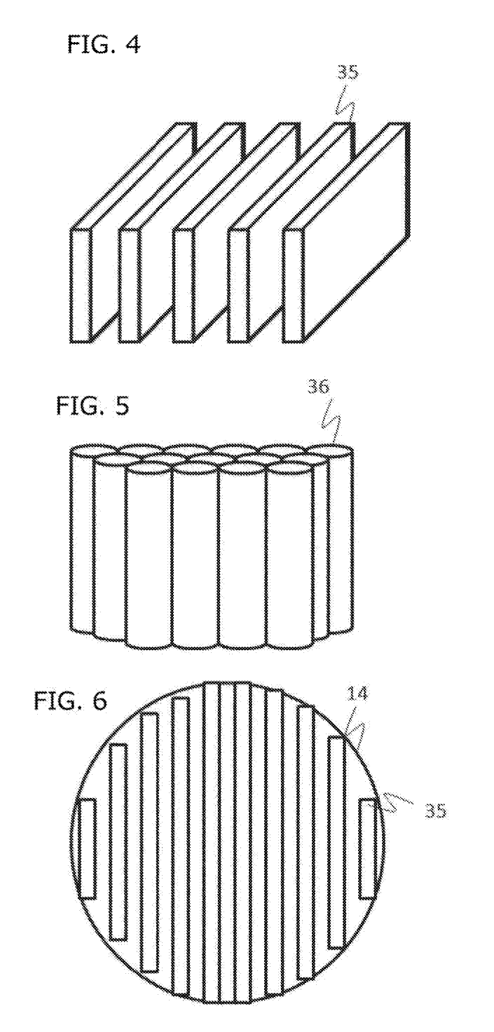

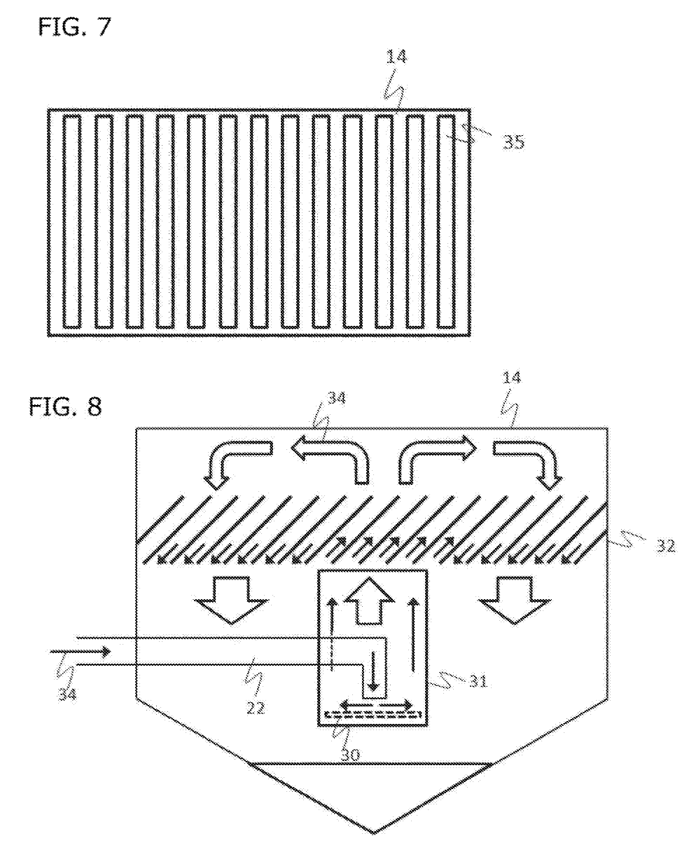

Examples of the structure of the flow regulator 32 include a structure as shown in FIG. 4 in which plates (referred to as flow regulating plates) are arranged adjacently each other over a horizontal cross section of the ozone reaction tank, and a structure as shown in FIG. 5 in which cylinders (referred to as flow regulating cylinders) are arranged adjacently each other throughout a horizontal cross section of the ozone reaction tank. Incidentally, FIG. 4 shows flow regulating plates 35, and FIG. 5 shows flow regulating cylinders 36. FIG. 6 shows a horizontal cross section in a case where the flow regulating plates 35 are used as a flow regulator and the ozone reaction tank 14 of a circular shape is used, and FIG. 7 shows a horizontal cross section in a case where a rectangular-shaped water tank is used.

As described above, since upward flow occurs in the central area of the ozone reaction tank 14, on the outer periphery of the ozone reaction tank 14, that is, the outside of the baffle plate, downward flow as shown in FIG. 5 occurs. In the downward flow, by a flow regulation effect, when the flow passes through the flow regulator 32 downwardly from above, a mild flow without turbulence is formed below the flow regulator 32.

In the course of the upward flowing through the guide pipe, the microorganism-mixed liquid flow 34 is vigorously turbulent. However, as described above, since the turbulence is suppressed by the flow regulator 32, solid matter, that is, the microorganisms, contained in the microorganism-mixed liquid 7, becomes likely to settle by its own weight. This allows the solid matter in the microorganism-mixed liquid, that is, the undecomposed microorganisms, to settle at a site outside the baffle plate where the flow is mild, and the undecomposed microorganisms settle and are concentrated on the bottom of the ozone reaction tank 14. That is, the flow regulator 32 is one example of the flow regulation means according to the present invention.

For achieving the flow regulation effect by the flow regulator 32 as described above, for example, in the case where the flow regulating plates as shown in FIG. 4 are used, an excessively large interval between plates is not preferred. Also, an excessively small interval causes clogging between the flow regulating plates with the solid matter contained in the microorganism-mixed liquid 7 and the flow regulation effect is impaired. Accordingly, a suitable interval may be made such that the proportion of the horizontal cross sectional area of the spaces between flow regulating plates relative to the horizontal cross sectional area of the ozone reaction tank 14 is 10 to 50%, and preferably 10 to 40%, and the plural flow regulating plates are preferably disposed at an equal interval. In addition, the same is applied in the flow regulating cylinders as shown in FIG. 5, and it is preferred that the cylinders having an equal cross sectional area are arranged throughout a horizontal cross section of the ozone reaction tank 14 so that the proportion of the cross sectional area of the hollow portions in the cylinders relative to the horizontal cross sectional area of the ozone reaction tank 14 is 10 to 50%, and preferably 10 to 40.

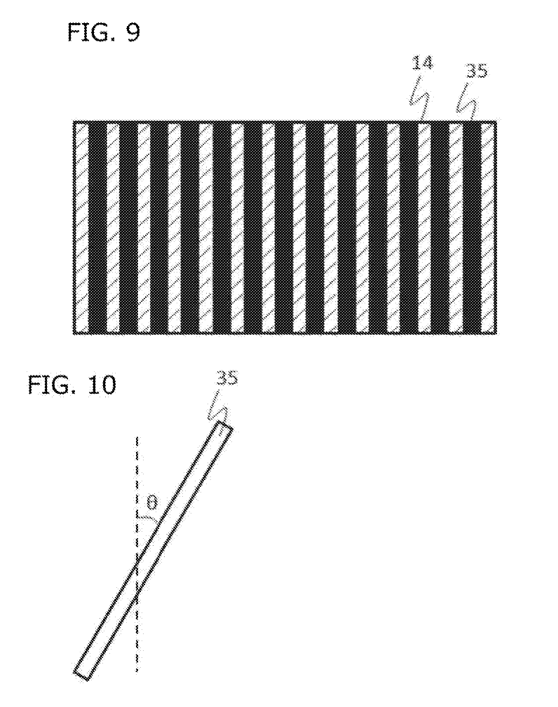

Incidentally, the proportion of the horizontal cross sectional area of the spaces between the flow regulating plates, or the hollow portions of the flow regulating cylinders, that is, the hatched area shown in FIG. 9, relative to the horizontal cross sectional area of the ozone reaction tank 14 is referred to as an “aperture ratio”.

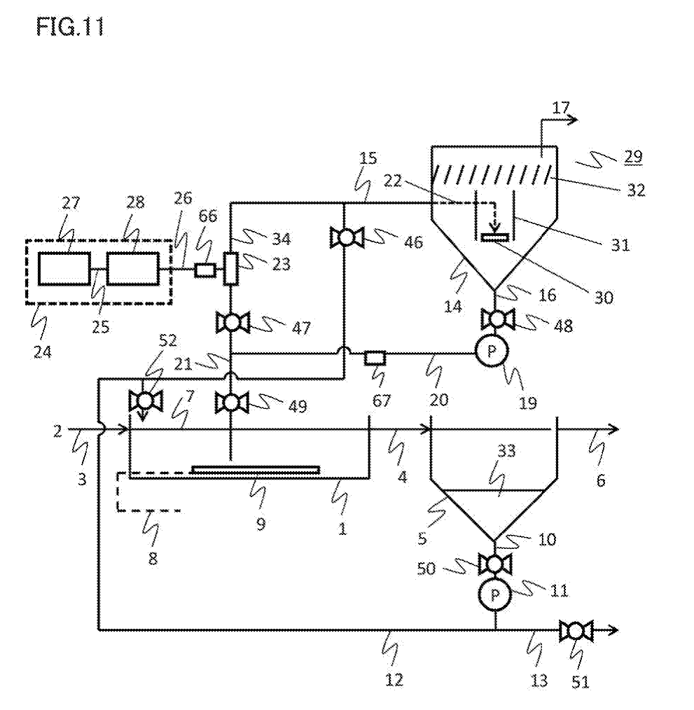

Furthermore, the flow regulating plates and the flow regulating cylinders shown in FIG. 4 and FIG. 5 may be inclined at an angle with respect to the vertical direction. When an angle θ, that is, an angle shown in FIG. 10, is excessively large, the solid matter is likely to accumulate on the inclined plates or on the inclined cylinders and may cause clogging of the flow path or damage of the apparatus. Accordingly, the inclination angle with respect to the vertical direction may be 0 to 60 degrees, and preferably 0 to 50 degrees.

The present invention is characterized by repeatedly performing the ozone injecting and circulating stage and the sludge concentrating stage of predetermined times. Accordingly, in the sludge concentrating stage, the solid matter in the microorganism-mixed liquid 7 accumulating on the bottom of the ozone reaction tank 14, that is, the undecomposed microorganisms, is withdrawn via the sludge extracting pipe 16 by the sludge circulating pump 19, and introduced again into the sludge circulating pipe 20 and comes into contact with ozone.

The remaining ozone that has not been consumed by the reaction among the ozone injected as described above is transferred into an ozone decomposer (not shown) via the ozone releasing path 17 as an exhaust gas, detoxified therein and dissipated into the atmosphere.

### <Method and Conditions for Operation>

Hereinunder, conditions for performing the ozone treatment stage for achieving the maximum effect of the present invention will be described.

### [Amount of Ozone Injected]

In the configuration of the present invention, an amount of ozone required for dissolving microorganisms in a microorganism-mixed liquid (an amount required for one ozone treatment stage) is obtained with the following expression, according to the intensive study of the inventors of the present application.

[O₃ dosage]={[MLSS]×α}×[V]×β Expression 1

[O₃ dosage]: amount of injected ozone required (mgO₃/time)
[MLSS]: solid matter concentration in aeration tank (g/L)
[V]: amount of microorganism-mixed liquid treated at one time (L/time)
α: MLSS/MLVSS ratio
β: amount of ozone required for MLVSS decomposition (mgO₃/gMLVSS)

α indicates a ratio of the amount of solid matter derived from microorganisms (MLVSS) in the solid matter concentration in the aeration tank (MLSS), and is generally 0.4 to 0.7 although it varies for each wastewater. β indicates an amount of ozone required for decomposing a unit amount of MLVSS, and is from 20 to 70 mgO₃/gMLVSS according to the study of the present inventors. β is from 30 to 60 mgO₃/gMLVSS in many cases, and preferably set in this range.

[MLSS] can be obtained by measuring MLSS in the aeration tank, and [V] is determined by arbitrarily regulating the amount of the microorganism-mixed liquid transferred from the aeration tank to the ozone reaction tank 14. Since it is not preferred that the volume of the ozone reaction tank is excessively large, [MLSS] may desirably be 0.1 to 7%, and preferably 0.2 to 5% based on the aeration tank volume. [A] may be determined by sampling and analysis of the microorganism-mixed liquid performed by a system manager as the need arises, or may be determined by using a measurement value of an MLSS concentration meter which is previously placed in the aeration tank.

### [Number of Times of Ozone Treatment Stage Performed Per Day]

In the water treatment system according to Embodiment 1, microorganisms are decomposed by ozone, a liquid after the ozone treatment is returned to the aeration tank, and organic substances contained in the liquid is allowed to be utilized by microorganisms, thereby reducing sludge. It is the relation: “the amount of microorganisms decomposed by ozone≠the amount of sludge reduced” that is to be considered here. In other words, since the microorganisms in the aeration tank utilize the decomposed microorganisms contained in the liquid after the ozone treatment to perform new production, new microorganisms are generated in the aeration tank. However, the amount of the microorganisms generated is smaller than the amount of the microorganisms decomposed by ozone treatment, resulting in achieving reduction of sludge.

Owing to the complicated relation, in order to fully achieving the effect of the excess sludge reduction by ozone according to the present invention, it is desired, in addition to that ozone is injected in the amount calculated by Expression 1, that the amount of the microorganism-mixed liquid treated at one time ([V] in Expression 1) and the number of times of the ozone treatment stage performed per day [F] are set so as to give a “treated sludge ratio” of 1.5 to 6, preferably 2 to 5.

Here, the treated sludge ratio refers to a ratio of an amount of sludge subjected to the ozone treatment per day relative to an amount of excess sludge per day generated without the ozone treatment, and calculated by the following expression.

[R]=[Q1]/[Q2] Expression 2

[R]: treated sludge ratio
[Q1]: amount of sludge subjected to ozone treatment per day (gMLSS/day)
[Q2]: amount of excess sludge per day (gMLSS/day)

[Q1] is an MLSS weight that is subjected to the ozone treatment per day, and calculated as the product of the solid matter concentration in the aeration tank ([SS] in Expression 1), the amount of the microorganism-mixed liquid treated at one time ([V] in Expression 1), and the number of times of the ozone treatment stage performed per day. Accordingly, [Q1] is as follows.

[Q1]=[MLSS]×[V]×[F] Expression 3

[Q1]: amount of sludge subjected to ozone treatment per day (gMLSS/day)
[MLSS]: solid matter concentration in aeration tank (g/L)
[V]: amount of microorganism-mixed liquid treated at one time (L/time)
[F]: number of times of ozone treatment stage performed per day (times/day)

[Q2] refers to the weight of excess sludge generated without the ozone treatment as described above. [Q2] may be calculated in advance from results of daily measurement of the solid matter concentration in the aeration tank before starting the excess sludge reduction by ozone according to the present invention, or may be calculated by the following expression even after applying the present invention.

[Q2]={{[BODᵢₙ]−[BODₒᵤₜ]×γ+{[SSᵢₙ]−[SSₒᵤₜ]}}×[W] Expression 4

[Q2]: amount of excess sludge per day (gMLSS/day)
[BODᵢₙ]: BOD contained in wastewater (g/L)
[BODₒᵤₜ]: BOD contained in treated water (g/L)
[W]: amount of wastewater flowing-in per day (L/D)
γ: sludge conversion
[SSᵢₙ]: solid matter concentration in wastewater (g/L)
[SSₒᵤₜ]: solid matter concentration in treated water (g/L)

Here, BOD is a biological oxygen demand, and a measure of an amount of organic substances contained in water. γ is a sludge conversion, that is, a proportion of organic substances that are converted to microorganisms in flowing-in organic substances, and is generally 0.1 to 0.4. [SSᵢₙ] and [SSₒᵤₜ] are solid matter concentrations in a flowing-in wastewater and a flowing-out treated water, respectively.

From the foregoing, the number of times of the ozone treatment stage performed per day [F] can be obtained by the following expression.

[F]={[R]×[Q2]}/{[MLSS]×[V]} Expression 5

[F]: number of times of ozone treatment stage performed per day (times/day)
[R]: treated sludge ratio
[Q2]: amount of excess sludge per day (gMLSS/day)
[MLSS]: solid matter concentration in aeration tank (g/L)
[V]: amount of microorganism-mixed liquid treated at one time (L/time)

Accordingly, it is desired that the number of times of the ozone treatment stage calculated as above are performed in a manner that the intervals of the performances are equal.

### [Time Period of Ozone Treatment Stage]

The time period of the ozone treatment stage [T1] has to be such a time period that allows the number of times calculated by Expression 5 as described above to be performed in one day. In addition, [T1] has to be such a time period that allows all the microorganism-mixed liquid stored in the ozone reaction tank to pass through the ejector to come into contact with ozone gas. Furthermore, [T1] has to be such a time period that allows the [O₃ dosage] calculated in Expression 1 mentioned above to be injected.

Accordingly, the time period of the ozone treatment stage [T1] is desirably set so as to simultaneously satisfy the following three expressions.

[T1]+[T2]+[T3]≦24 (h/day)/[F] Expression 6

[T1]≧[V]/[C] Expression 7

[O₃ dosage]=[O₃ conc]×[O₃ flow]×[T1] Expression 8

[T1]: time period of ozone treatment stage (h/time)
[T2]: sum of time period of sludge transferring stage and time period of treated sludge returning stage (h/time)
[T3]: downtime (h/time)
[F]: number of times of ozone treatment stage performed per day (times/day)
[V]: amount of microorganism-mixed liquid treated at one time (L/time)
[C]: sludge circulating pump flow rate (L/h)
[O₃ dosage]: amount of injected ozone required (GO₃/time)
[O₃ conc]: ozone gas concentration (GO₃/L)
[O₃ flow]: ozone gas flow rate (L/h)

[T2] indicates a sum of the time period of the sludge transferring stage and the time period of the treated sludge returning stage described later (hereinafter, referred to as miscellaneous time). [T3] refers to a “downtime” where none of the sludge transferring stage, the ozone treatment stage, and the treated sludge returning stage is performed. In the present invention, the sludge transferring stage, the ozone treatment stage, and the treated sludge returning stage are performed in this order. Since the three stages are performed as one cycle and downtimes are provided between the cycles, a relation of Expression 6 has to be satisfied. [T2] and [T3] can be arbitrarily set, and, for example, [T2] may be 10 to 120 minutes, preferably 10 to 60 minutes, and [T3] may be 0 to 12 hours, preferably 3 to 12 hours.

As described above, [V] is 0.1 to 7%, and preferably 0.2 to 5% relative to the aeration tank volume. As described above, the ozone gas flow rate [O₃ flow] and the sludge circulating pump flow rate [C] are desirably set so as to satisfy g/L in the ejector of 0.05 to 0.4, preferably 0.1 to 0.3. The ozone gas concentration [O₃ conc] may be arbitrarily regulated in the range of 0.05G to 2 g/L, and preferably 0.1 to 2 g/L.

Under the above conditions, [T1] may be arbitrarily set.

Although the number of times of ozone treatment stage performed per day [F] and the time period of ozone treatment stage [T1] can be arbitrarily regulated as described above, it is not preferred that the ozone treatment is performed too frequently. This is because a slight amount of unreacted ozone, which remains in the microorganism-mixed liquid that has been treated with ozone, frequently flows in the aeration tank, then impairing the activity of the microorganism in the aeration tank to deteriorate the performance of the wastewater treatment.

Consequently, [F] is desirably set so that the sum of [T1], [T2], and [T3] is 30% or more, and preferably 40% or more relative to HRT (hydraulic retention time) of the aeration tank.

Based on the above description, in the present invention, it is possible to always allow the liquid in contact with ozone to contain undecomposed microorganisms at a high concentration, and by optimizing the amount of ozone injected, it is possible to allow undecomposed microorganisms to efficiently react with ozone.

<Treated Liquid Returning Stage>

After the ozone treatment stage is completed, the valve 47 on the sludge circulating pipe 20 is closed, whereas the valve 49 on the treated liquid returning pipe 21 is opened, and the microorganism-mixed liquid 7 after the ozone treatment stored in the ozone reaction tank is returned into the aeration tank 1. The microorganism-mixed liquid after the ozone treatment contains residue of the microorganism decomposed by ozone. The microorganisms in the aeration tank decompose and utilize the residue as a substrate, and the residue is dissipated into the air as carbon dioxide gas, thereby achieving the sludge reduction.

The sludge transferring stage, the ozone treatment stage, and the treated liquid returning stage described above, are conducted while the biological treatment stage and the ozone gas producing stage are performed, and are not started after the biological treatment stage and the ozone gas producing stage are stopped.

### Embodiment 2

FIG. 11 shows an example of the configuration of the apparatus of the present invention in the case where a “conventional activated sludge process” is applied in the biological treatment stage.

In FIG. 11, the sludge transferring pipe 15 is connected to the sludge returning pipe 12. In FIG. 7, the sludge transferring pump 18 is not provided. The configuration is the same as in FIG. 1 except for the above points.

In Embodiment 2, the separated sludge 33 accumulated on the sedimentation tank 5, that is, the microorganisms flowing out from the aeration tank 1 is transferred to the ozone reaction tank 14 and subjected to an ozone treatment. When the sludge transferring stage is started, the valve 46 on the sludge transferring pipe 15 is opened, and the microorganism-mixed liquid 7 flowing through the sludge returning pipe 12 is transferred through the sludge transferring pipe 15 into the ozone reaction tank 14.

The transfer amount may be controlled by the same method as in Embodiment 1. Other operations than the above are the same as in Embodiment 1. In addition, the operation conditions, such as the amount of ozone injected [O₃ dosage], the number of times of the ozone treatment stage performed per day [F], and the time period of the ozone treatment stage [T1], may be calculated by the expressions with the “solid matter concentration in the separated sludge (g/L)” substituted for “MLSS”, and the “amount of the separated sludge treated at one time (L/time)” substituted for [V].

### Embodiment 3

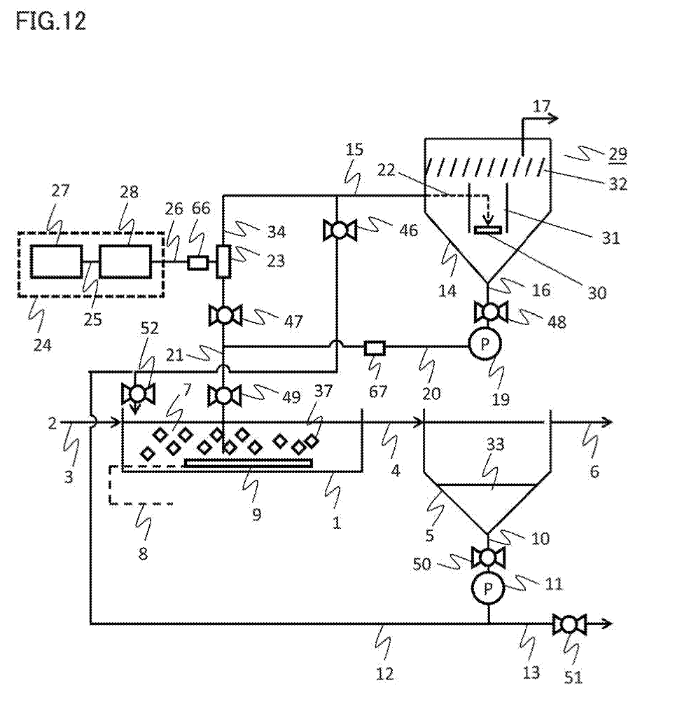

FIG. 12 shows an example of the configuration of the apparatus of the present invention in the case where a “biological membrane process” is applied in the biological treatment stage. In FIG. 12, microorganism carriers 37 are put in the aeration tank 1. The configuration is the same as in FIG. 11 (Embodiment 2) except for the above point.

The microorganism carriers put in the aeration tank are intended to have microorganisms deposited on the surface thereof to maintain the amount of organics in the aeration tank at a high level, and such a biological treatment technique is generally called “biological membrane process”. In the case where no carrier is put in the aeration tank, that is, the case of the “conventional activated sludge process” described in Embodiment 1, the floating microorganisms are allowed to utilize organic substances in a wastewater to purify the wastewater, whereas the biological membrane process is different in that purification is performed by microorganisms deposited and immobilized on carrier surfaces. However, the processes share a common point that they are wastewater purification by microorganisms. Also in the biological membrane process, a liquid containing microorganisms has to be allowed to flow out into the subsequent sedimentation tank for a solid-liquid separation, and the separated sludge has to be discarded as excess sludge. Accordingly, in the case where the biological membrane process is used in the biological treatment stage, the configuration in FIG. 12 is adopted and a part or all of the separated sludge 33 accumulating in the sedimentation tank 5 is transferred to the ozone treatment stage.

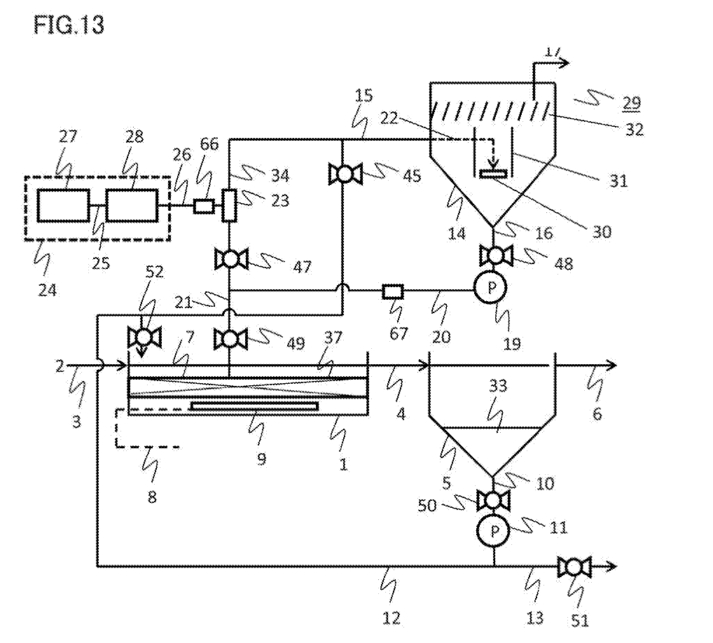

In addition, FIG. 12 illustrates a “fluid bed type” where sponge carriers or the like are placed, but a “fixed bed type” where the aeration tank is charged with a plastic filler as shown in FIG. 13 may be adopted.

In any configuration of FIG. 12 and FIG. 13, the operation is the same as in Embodiment 2.

Incidentally, in Embodiments 1 to 3, a sedimentation tank provided as a subsequent stage of the aeration tank is used as a solid-liquid separation device, but any device may be used as long as it has such a configuration that can perform solid-liquid separation and can transfer the separated sludge to the ozone treatment stage, and, for example, a floatation separation device and a centrifugal separation device may be used in place of the sedimentation tank.

### Embodiment 4

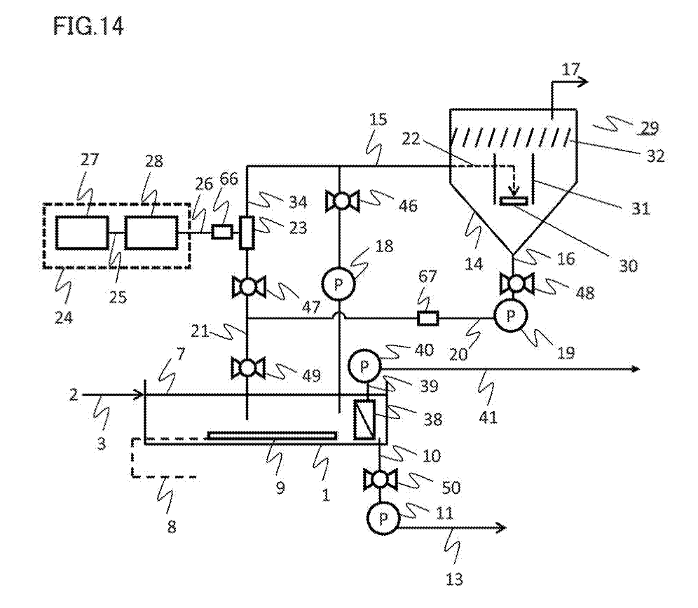

FIG. 14 shows a configuration of Embodiment 4. Embodiment 4 is an example of the configuration of the case where the “membrane bioreactor process (MBR)” is applied in the biological treatment stage.

A water treatment system in FIG. 14 includes the solid-liquid separation membrane 38, a filtrate suction pipe 39, a filtering pump 40, and a filtrate transferring pipe 41. In Embodiment 4, the sludge withdrawing pipe 10 is connected to the aeration tank 1. Since Embodiment 4 uses MBR, a solid-liquid separation means such as the sedimentation tank 5 does not have to be provided as a subsequent stage of the aeration tank. The configuration is the same as in FIG. 1 (Embodiment 1) except for the above points.

MBR shown in FIG. 14 is called “immersion-type MBR” since a solid-liquid separation membrane is immersed in the aeration tank. As with the case of the “conventional activated sludge process” shown in Embodiment 1, the immersion-type MBR is a process in which microorganisms floating in the aeration tank are allowed to utilize organic substances in a wastewater to remove the organic substances in the wastewater, and a microorganism-mixed liquid is subjected to solid-liquid separation with a solid-liquid separation membrane placed in the aeration tank, thereby obtaining a clear treated water. As compared with a conventional activated sludge process and the like, it is possible to reduce the space of the equipment and to enhance the quality of the treated water. MBR shares a common point that it is wastewater purification by microorganisms. Excess sludge, which is generated, is required to be discharged and discarded.

As described above, since the immersion-type MBR is the same as the “conventional activated sludge process” except that a solid-liquid separation is performed with a membrane which is immersed in the aeration tank 1, a microorganism-mixed liquid is withdrawn from the aeration tank, and then subjected to an ozone treatment, whereby the effect of the present invention can be achieved, as with the case of Embodiment 1.

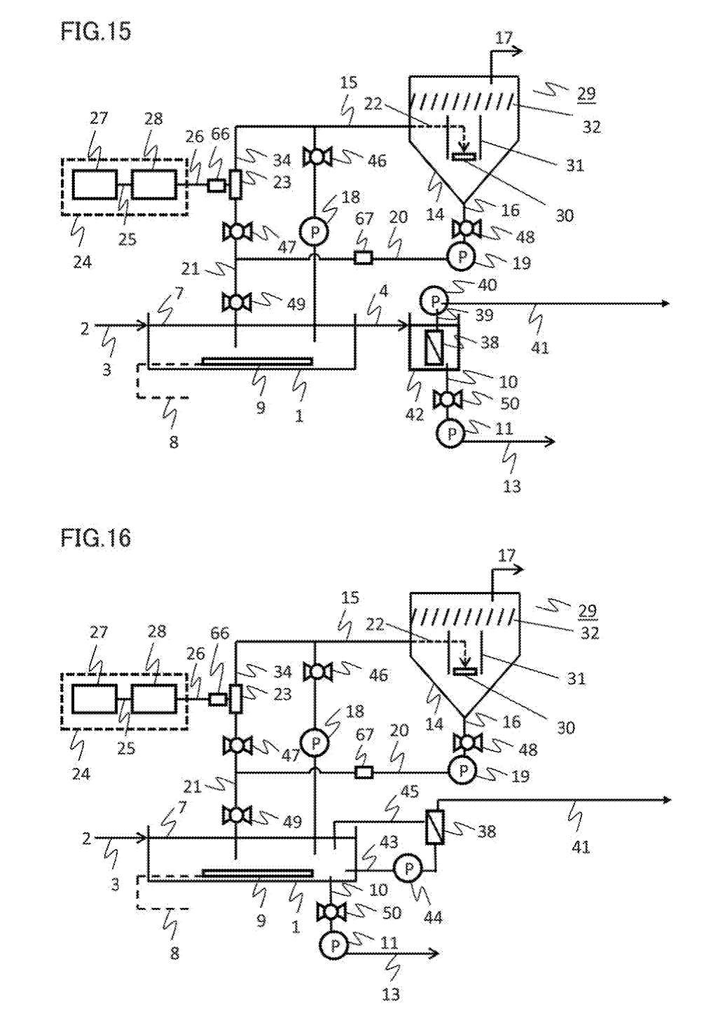

Although FIG. 14 shows a configuration of the case where an immersion-type MBR is applied in the biological treatment stage, for example, as shown in FIG. 15 or 16, a solid-liquid separation membrane may be provided outside the tank. Specifically, as shown in an example shown in FIG. 15, a membrane separation tank 41 having the solid-liquid separation membrane 38 placed therein may be provided, or as shown in an example shown in FIG. 16, a membrane water-feeding path 43, a membrane water-feeding pump 44, and a concentrated sludge retuning path 45 may be provided to place the solid-liquid separation membrane 38 outside the tank.

### Embodiment 5

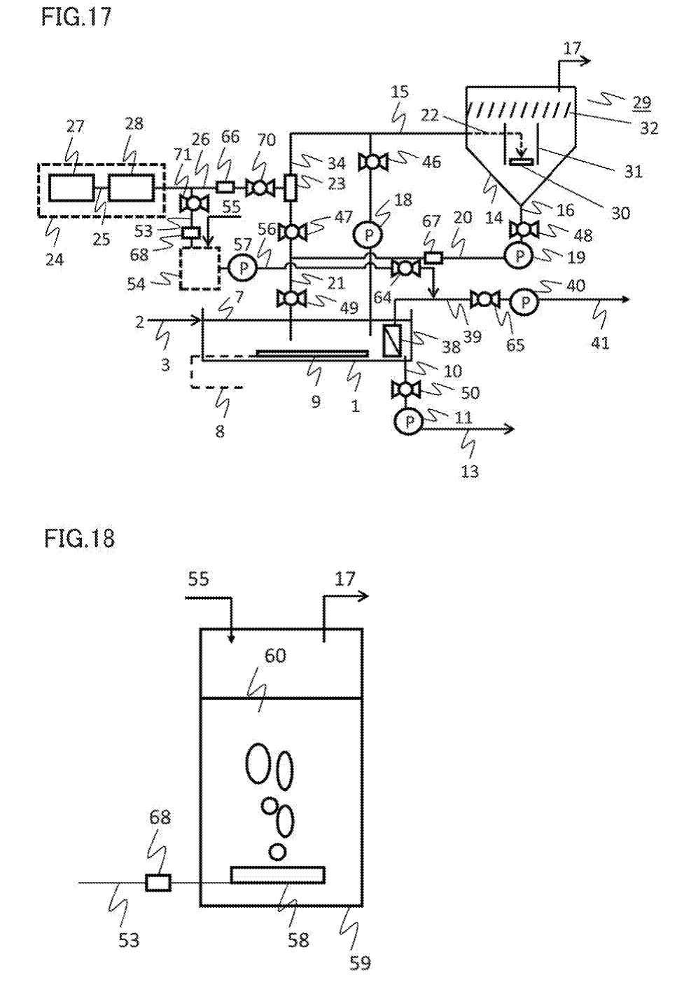

FIG. 17 shows another embodiment, Embodiment 5 of the present invention. As with the case of Embodiment 4, Embodiment 5 is an example of the case where the present invention is applied to MBR, and ozone produced in the ozone production device 24 is used for washing the solid-liquid separation membrane 38.

The solid-liquid separation membrane 38 filters under reduced pressure a microorganism-mixed liquid in the aeration tank 1 by driving the filtering pump 40. As the pressure inside the filtrate suction pipe 39 decreases (that is, as the transmembrane pressure difference increases), the solid-liquid separation membrane 38 is required to be washed. Although the membrane is typically washed with hypochlorous acid, in this embodiment, washing with ozone water which has a stronger washing effect is possible.

In FIG. 17, in addition to the configuration in FIG. 14, an ozone injecting branched path 53, an ozone water production unit 54, a treated water returning path 55, an ozone water transferring path 56, an ozone water feeding pump 57, and valves 70, 71 are provided.

After an increase in the transmembrane pressure difference is detected as described above, an ozone water producing stage is started. In an ozone water washing stage, the valve 71 is opened, and an ozone gas concentrated by the ozone concentrator 28 is fed via the ozone injecting branched path 53 connected to the ozone injecting path 26 to the ozone water production unit. On the other hand, a treated water returning path 55 is connected to the ozone water production unit 54, and a part of the treated water treated in the biological treatment stage and released is returned to the ozone water production unit. The aforementioned ozone gas comes in contact with the treated water in the ozone water production unit 54 to produce an ozone water.

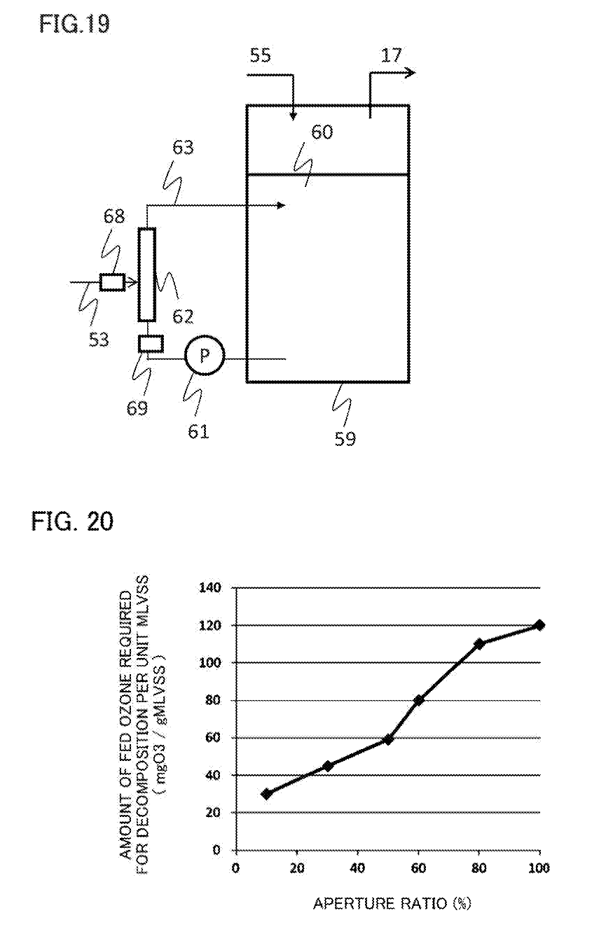

As a configuration of the ozone water production unit, for example, those shown in FIG. 18 and FIG. 19 are exemplified. The ozone water production unit illustrated in FIG. 18 includes an ozone gas diffuser 58, an ozone water tank 59, and a treated water 60. An ozone gas introduced through the ozone gas injecting branched path 53 is dissipated from the ozone gas diffuser 58, and ozone is dissolved in the treated water 60 received in the ozone water tank 59, thereby producing an ozone water.

An ozone water production unit illustrated in FIG. 19 includes an ozone water circulating pump 61, an ozone water producing ejector 62, and an ozone water circulating pipe 63. Flowmeters 68 and 69 are placed on the ozone injecting branched path 53 and the ozone water circulating pipe 63, respectively. The treated water 60 received in the ozone water tank flows through the ozone water circulating pipe 63 by the ozone water circulating pump 61. On the other hand, the ozone water producing ejector 62 is placed on the ozone water circulating pipe 63, and also connected to the ozone injecting branched path 53. The treated water 60 flows through the ozone water circulating pipe, and in the course of passing through the ozone water producing ejector 62, absorbs a high-concentration ozone gas via the ozone injecting branched path 53, and comes in contact with ozone, thereby producing an ozone water. An ozone gas flow rate and an ozone water circulating pump-ejecting flow rate are desirably regulated so that g/L in the ozone water producing ejector 62 is also 0.1 to 0.3.

The time period required for the ozone water production depends on the ozone gas concentration, but, for example, when using an approximately 300 mgO₃/NL ozone gas, the gas is desirably diffused or circulated for a time period between 5 and 60 minutes. As a result, the ozone water of at least 60 mgO₃/L or more in terms of a concentration of the dissolved ozone can be produced. When the ozone gas concentration is made higher, the ozone water concentration can also be made higher.

As described above, the ozone water producing stage is started by detecting an increase in the transmembrane pressure difference, and when the ozone water producing stage is completed, the process proceeds to the membrane washing stage.

In the membrane washing stage, the ozone water produced in the ozone water production unit 54 is injected into the secondary side of the solid-liquid separation membrane through the ozone water transferring path 56 by the ozone water feeding pump 57. At this time, the valve 64 is opened and the valve 65 is closed. The filtering pump 40 is out of operation and the filtration under reduced pressure with the solid-liquid separation membrane 38 is in a resting state.

Although the amount of washing water and the time period of washing depend on the ozone water concentration used for the washing, for example, when an ozone water of approximately 60 mgO₃/L in terms of the concentration of the dissolved ozone is used for the washing, it is sufficient that the amount of washing water is 0.5 to 5 L/m², preferably 0.5 to 3 L/m² per unit membrane area of the solid-liquid separation membrane 38, and that the time period of washing is 5 to 120 minutes, preferably 5 to 90 minutes.

When the washing with the ozone water is completed, by stopping the ozone water feeding pump 57, opening the valve 65, closing the valve 64, and driving again the filtering pump 40, the filtration of the microorganism-mixed liquid 7 under reduced pressure is restarted.

Incidentally, the ozone water producing stage and the membrane washing stage described above can be performed at the same time with the ozone treatment stage of sludge, and when the stages are performed at the same time, the valve 70 is opened, and the ozone gas released from the ozone concentrator 28 is fed to both of the ozone water production unit 54 and the ejector 23.

Other operations are the same as in Embodiment 4.

In addition, a process in which an ozone water is produced to be used for washing a solid-liquid separation membrane as described in this embodiment can be applied to MBR, for example, having a form as shown in FIGS. 15 and 16.

### EXAMPLES

In the apparatus having a configuration of FIG. 14, the effect of the present invention is shown based on a test of wastewater treatment.

An artificial sewage was used as a test water. Therefore, the properties of the wastewater and the amount of the treated water were always constant. In Examples 1 and 2, sludge was appropriately discharged from an aeration tank to maintain the MLSS concentration and the MLVSS/MLSS ratio constant. Incidentally, details of the properties of the wastewater and the conditions of the test apparatus are shown in Table 1 and Table 2. An inclined plates were used as a flow regulator.

TABLE 1
It is a table for explaining conditions of
experiments for verifying the effect of the present invention.

| Properties | pH | 7.5 | |
|---|---|---|---|
| of | BOD | 200 | mg/L |
| wastewater | T-SS | 100 | mg/L |
| Conditions | Amount of treated water | 5000 | L/D |
| of test | Aeration tank | 2000 | L |
| apparatus | Volume of ozone reaction tank | 72 | L |
| | ([V] Amount of microorganism-mixed | | |
| | liquid treated at one time) | | |
| | MLSS | 6900 | mg/L |
| | MLVSS | 2760 | mg/L |
| | [Q1] Amount of excess sludge generated | 850 | qMLSS/day |

TABLE 2
It is a table for explaining conditions of
experiments for verifying the effect of the present invention.

| | | | |
|---|---|---|---|
| Conditions of | [O3 conc] Ozone gas concentration | 200 | mg/L |
| ozone treatment | [O3 flow] Ozone gas flow rate | 49.7 | L/h |
| (Example 1) | [C] Sludge circulation pump flow rate | 184 | L/h |

| | |
|---|---|
| G/L | 0.27 |
| [α] MLSS/MLVSS ratio | 0.4 |

### Example 1

Example 1 shows results of ozone treatments of a microorganism-mixed liquid conducted while varying the flow regulating plate interval, that is, the aperture ratio. However, the flow regulating plate intervals were equal.

### [Test Method]

In Example 1, the verification was conducted by a method in which while performing a biological treatment stage, an ozone treatment stage was started and stopped at an arbitrarily timing.

The microorganism-mixed liquid in the ozone reaction tank was sampled at every fixed time from the start of the ozone treatment stage, and subjected to an MLVSS concentration measurement. From the results, a time period required for completely decomposing MLVSS was grasped. From the time period, the amount (weight) of ozone fed during the time period was calculated.

The above operation was conducted for each aperture ratio and the amounts of ozone fed were compared among the aperture ratios. Incidentally, the angle θ of the inclined plates with respect to the vertical direction was 45 degrees. The conditions for the ozone treatment, such as the ozone concentration, are shown in Table 2.

### [Results]

FIG. 12 shows the relation between the aperture ratio and the value obtained by dividing the amount of ozone fed by the amount of MLVSS decomposed, that is, the amount of ozone required for decomposition per unit MLVSS.

It is apparent from FIG. 12 that, with an aperture ratio of 10 to 50%, the weight of ozone required for decomposition was 30 to 59 mgO₃/gMLVSS per unit MLVSS weight, but when the aperture ratio exceeded 50%, the weight of ozone rapidly increased and the efficiency of decomposition deteriorated. This indicates that as the interval between flow regulating plates increases, the flow regulation effect is reduced and it becomes difficult to separate and concentrate the undecomposed microorganisms and the microorganisms and organic substances. Thus, ozone is consumed by other organic substances than the microorganisms, resulting in deterioration in the efficiency of decomposing microorganism.

In FIG. 20, the 100% aperture ratio represents a configuration including no flow regulator. That is, it shows a configuration of a conventional wastewater treatment system.

When the aperture ratio was less than 10%, the flow paths between the inclined plates were clogged with the microorganisms, and the flow regulation effect could not be obtained so that the separation and concentration of the undecomposed microorganism could not be achieved.

From the foregoing, it was demonstrated that the aperture ratio is suitably 10 to 50%, and that sludge can be decomposed with a clearly smaller amount of ozone fed than that in the conventional apparatus.

### Example 2

In Example 2, an ozone treatment was conducted using inclined plates as a flow regulator as with the case of Example 1, while varying the inclination angle θ of the inclined plates with respect to the vertical direction. However, the aperture ratio was fixed to 30%.

Also in Example 2, the verification was conducted by a method in which an ozone treatment stage was started and stopped at an arbitrarily time as with the case of Example 1. The conditions for the ozone treatment were the same as in Example 1 and shown in Table 2.

The results are shown in Table 3. When the angle was larger than 60 degrees, solid matter accumulated on the flow regulator or between the inclined plates, and the paths between the inclined plates were clogged. For this reason, the flow regulation effect in the flow regulator could not be obtained, and separation and concentration of the undecomposed microorganism could not be achieved. From the foregoing, it was demonstrated that the inclination angle of the inclined plates with respect to the vertical direction is suitably 0 to 60 degrees.

TABLE 3
It is a table for explaining the verification results of the flow
regulator structure in the present invention.

| | Angle of inclined plates (degree) | | | | | |
|---|---|---|---|---|---|---|
| | 0 | 20 | 50 | 60 | 70 | 80 |
| Occurrence of clogging | No | No | No | No | Yes | Yes |

### Example 3

In Example 3, verification was conducted for the excess sludge reduction effect and the wastewater treatment performance, by carrying out a continuous treatment for 40 days after completion of the verification in Example 1 and 2.

During the test period, as shown in Table 4, the treatment conditions was varied at every 10 days, and the respective treated water qualities in the conditions were compared. Also in this Example, the artificial sewage shown in Table 1 was used as a wastewater.

TABLE 4
It is a table for explaining the conditions of
a test for verifying the effect of the present invention.

| | 0 to 10 | 11 to 20 | 21 to 30 | 31 to 40 |
|---|---|---|---|---|
| Experiment period | days | days | days | days |
| Ozone treatment | No | Yes | Yes | Yes |
| Flow regulator | No | Yes | No | No |
| Ratio of ozone injection amount | — | 1 | 1 | 2.4 |

### Period 1

In Period 1, no ozone treatment, but only a biological treatment stage was performed. Withdrawal from an aeration tank was appropriately performed to maintain the MLSS concentration in the aeration tank constant.

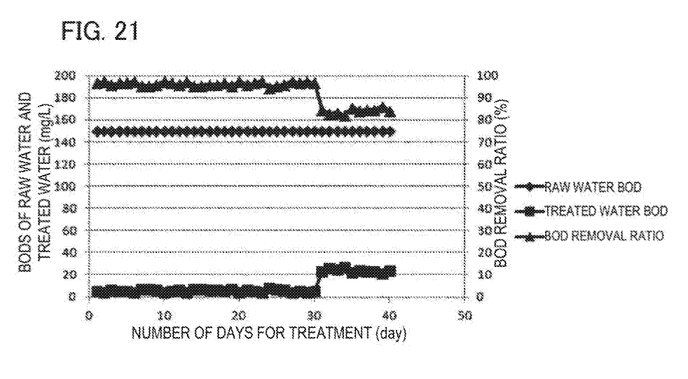

In Period 1, the treated water quality was stable, and the BOD removal ratio was generally approximately 95% over the period (FIG. 21). In addition, the amount of sludge discharged per day was approximately 850 gMLSS/day.

### Period 2

In Period 2, an ozone treatment was started with the present invention applied. The conditions for the flow regulator and the ozone treatment are shown in Table 5. Also in Period 2, the MLSS concentration in the aeration tank was maintained constant.

TABLE 5
It is a table for explaining the conditions of
the experiments for verifying the effect of the present
invention.

| Conditions of | Types | Inclined plates | |
|---|---|---|---|
| flow regulator | Aperture ratio | 30% | |
| | θ | 45 | degrees |
| Conditions of | [O3 conc] Ozone gas | 200 | mg/L |
| ozone | concentration | | |
| treatment | [O3 flow] Ozone gas flow rate | 49.7 | L/h |
| (Example 3) | [C] Sludge circulation pump flow | 184 | L/h |
| | rate | | |
| | G/L | 0.27 | |
| | [α] MLVSS/MLSS ratio | 0.4 | |
| | [β] Amount of ozone required for | 50 mgO3/ | |
| | MLVSS decomposition | gMLVSS | |
| | [O3 dosage] Amount of injected | 9936 mgO3/ | |
| | ozone required | time | |
| | [R] Treated sludge ratio | 3.5− | |
| | [F] Number of times of ozone | 6 | |
| | treatment stage performed per day | | |
| | [T1] Time period for ozone | 1 | hr |
| | treatment stage | | |
| | [T2] Miscellaneous time | 1 | hr |
| | [T3] Downtime | 2 | hr |

Also in Period 2, the treated water quality was stable, and the BOD removal ratio was generally approximately 95% as with the case of Period 1 (FIG. 21).

An excess sludge reduction effect by ozone was obtained, and in Period 2, the amount of sludge discharged per day was approximately 400 gMLSS/day, that is, the amount of excess sludge reduced was 450 gMLSS/day.

### Period 3

In Period 3, the flow regulator was taken off from the ozone reaction tank and an ozone treatment was conducted. That is, a treatment was conducted with the same configuration as in the related art. In addition, also in this period, the aeration tank MLSS was made constant by discharging sludge. Also in the period, the ozone treatment conditions were those shown in Table 5 as with the case of Period 2.

Also in Period 3, the treated water quality was stable, as with the cases in Periods 1 and 2 (FIG. 21).

However, the excess sludge reduction effect was not fully obtained, and in spite of the amount of ozone injected which is the same as in Period 2, the amount of sludge discharged per day was 700 gMLSS/day, that is, the amount of excess sludge reduced was 150 gMLSS/day.

This is because the injected ozone was consumed by the organic substances leaked from the decomposed microorganisms and the microorganisms was not fully decomposed. This revealed again the superiority of the water treatment system according to the present invention in which a flow regulator is provided in an ozone reaction tank and an ozone treatment is conducted while separating and concentrating undecomposed microorganisms by allowing the undecomposed microorganisms to easily settle.

### Period 4

In Period 4, an ozone treatment was conducted with no flow regulator provided in the ozone reaction tank as with the case of Period 3. Furthermore, in view of the fact that the sludge reduction effect was not fully obtained in Period 3, a treatment was performed while setting the time period for the ozone treatment stage [T1] to 2.4 hours, the miscellaneous time [T2] to 1 hour, and the downtime [T3] to 0.6 hours, so as to make the amount of ozone injected [O₃ dosage] 2.4 times. The other conditions for the ozone treatment were the same as in Period 3. Also in Period 4, MLSS in the aeration tank was made constant by discharging sludge.

As a result, the excess sludge reduction effect could be fully obtained, with the amount of sludge discharged per day being 400 gMLSS/day and the amount of excess sludge reduced being 450 gMLSS/day.

However, deterioration was recognized in the treated water quality with the BOD removal ratio being around 80% (FIG. 13). This is because, among the injected ozone, unreacted ozone remained in the liquid after the ozone treatment, which lowered the microorganism activity in the aeration tank.

In the case where the contact efficiency is low between the undecomposed microorganisms and ozone in the ozone reaction tank, as with the case of the related art, a large excess amount of ozone has to be injected until the sludge reduction effect is fully obtained, and an amount of ozone will then remain in the liquid.

Different modification examples and effects can be easily derived by a person in the art and are not to be limited to the specific details and the typical embodiments explained and described above. Accordingly, various modifications can be made without departing from the comprehensive concept and scope of the invention defined by the accompanying claims and equivalents thereof.

### REFERENCE SIGNS LIST

1: aeration tank, 2: wastewater, 3: wastewater introducing path, 4: flow-out path, 5: sedimentation tank, 6: treated water releasing path, 7: microorganism-mixed liquid, 8: air introducing path, 9: air diffuser, 10: sludge withdrawing pipe, 11: sludge withdrawing pump, 12: sludge returning pipe, 13: sludge discharging pipe, 14: ozone reaction tank, 15: sludge transferring pipe, 16: sludge extracting pipe, 17: ozone releasing path, 18: sludge transferring pump, 19: sludge circulating pump, 20: sludge circulating pipe, 21: treated liquid returning pipe, 22: sludge introducing pipe, 23: ejector, 24: ozone production device, 25: ozone transferring path, 26: ozone injecting path, 27: ozone generator, 28: ozone concentrator, 29: sludge concentration and separation device, 30: baffle plate, 31: guide pipe, 32: flow regulator, 33: separated sludge, 34: microorganism-mixed liquid flow, 35: flow regulating plate, 36: flow regulating cylinder, 37: microorganism carrier, 38: solid-liquid separation membrane, 39: filtrate suction pipe, 40: filtering pump, 41: filtrate transferring pipe, 42: membrane separation tank, 43: membrane water-feeding path, 44: membrane water-feeding pump, 45: concentrated sludge returning path, 46 to 52: valve, 53: ozone injecting branched path, 54: ozone water production unit, 55: treated water returning path, 56: ozone water transferring path, 57: ozone water feeding pump, 58: ozone gas diffuser, 59: ozone water tank, 60: treated water, 61: ozone water circulating pump, 62: ozone water producing ejector, 63: ozone water circulating pipe, 64 to 65: valve, 66 to 69: flowmeter, 70 to 71: valve

1: A water treatment system, which includes a microorganism treatment unit configured to treat a water with a microorganism, a withdrawing unit configured to withdraw a partial water from the water treated by the microorganism treatment unit, a water tank having a height in the vertical direction and configured so that the partial water withdrawn by the withdrawing unit flows therein and is stored therein, an ozone generation unit configured to generate ozone, and an ozone reaction unit configured to allow the partial water to react with the ozone generated by the ozone generation unit, and which treats the water, the water treatment system comprising:
a returning unit connected to an underside in the vertical direction of the water tank, and configured to return at least a part of the partial water stored in the water tank to the microorganism treatment unit, and
a circulating means configured to withdraw the partial water stored in the water tank from a lower portion of the water tank and circulate the partial water to the ozone reaction unit; and
a flow-in means configured to allow the partial water circulated by the circulation means to react with the ozone generated by the ozone generation unit and to flow again into the water tank, wherein
the water tank is provided with a moving means that moves the partial water downwardly flowing therein upwardly in the vertical direction and a flow regulation means that is disposed above the moving means and regulates flow of the partial water moved by the moving means, and
the circulation means circulates the partial water moved by the moving means, regulated in flow by the flow regulation means, and stored in the lower portion of the water tank.

2: The water treatment system according to claim 1, wherein
the moving means is a baffle plate, and
the partial water reacted by the ozone reaction unit flows-in from above in the vertical direction toward the baffle plate.

3: The water treatment system according to claim 2, wherein
the flow regulation means includes a plurality of plate-like members spaced apart from each other,
the horizontal cross sectional area of the space between the plurality of plate-like members is 10 to 50% relative to the horizontal cross sectional area of the water tank, and
the plurality of plate-like members are each inclined by 0 to 60 degrees with respect to the vertical direction.

4: The water treatment system according to claim 2, wherein
the flow regulation means includes a plurality of cylindrical members,
the horizontal cross sectional area of the hollowed portions of the plurality of cylindrical members is 10 to 50% relative to the horizontal cross sectional area of the water tank, and
the plurality of cylindrical members are each inclined by 0 to 60 degrees with respect to the vertical direction.

5: The water treatment system according to claim 1, wherein
the ozone reaction unit includes a venturi device configured to inject the ozone generated into the partial water circulated by the circulation means.

6: The water treatment system according to claim 1,
which includes a concentration unit configured to concentrate the ozone generated, and is configured to allow the ozone concentrated by the concentration unit to react with the partial water circulated by the circulation means.

7: A water treatment process which includes a treating step for treating a water with a microorganism, the water treatment process comprising:
a withdrawing step for withdrawing a partial water from the water treated;
a storing step for allowing the partial water withdrawn to flow into a water tank having a height in the vertical direction and storing the partial water therein;
a moving step for moving the partial water flowing downwardly in the vertical direction in the water tank upwardly in the vertical direction;
a flow regulating step for regulating flow of the partial water moved;
a circulating step for withdrawing at least a part of the partial water regulated in flow and stored in the water tank from a lower portion of the water tank and circulating the at least a part of the partial water to the ozone reaction unit,
a generating step for generating ozone;
a reacting step for allowing the partial water circulated to react in the ozone reaction unit with the ozone generated;
a re-flow-in step for allowing the partial water reacted to flow again into the water tank, and
a retreating step for treating again a stored substance moved upwardly, regulated in flow, and stored in the lower portion of the water tank, after the re-flow-in, with the microorganism.

8: The water treatment process according to claim 7, wherein
the time period from starting the withdrawing step to starting again the withdrawing step is 30% or more of the time period for treating the water with the microorganism.

9: The water treatment process according to claim 8, wherein
the generating step includes a concentrating step for concentrating the ozone generated, and
the reacting step allows the partial water circulated to react with the ozone concentrated.

10: The water treatment process according to claim 7, wherein
the treating step and the retreating step perform a treatment by using a membrane bioreactor process.
